(19) United States
(12) Patent Application Publication
(10) Pub. No.: US 2002/0037097 A1
(43) Pub. Date: Mar. 28, 2002

(54) Coupon recognition system

(76) Inventors: Hector Hoyos, Guaynabo, PR (US); Alex Rivera, San Juan, PR (US); Miguel Berrios, Guaynabo, PR (US); Inaki Olivares, San Juan, PR (US); Michelle Viera-Vera, Carolina, PR (US)

Correspondence Address: Patent Law Offices of, Health W. Hoglund, 391 Juan A. Davila Street, San Juan, PR, 00918, US

(21) Appl. No.: 09/855,830

(22) Filed: May 15, 2001

Related U.S. Application Data
(60) Provisional application No. 60/204,440, filed on May 15, 2000.
(60) Provisional application No. 60/204,170, filed on May 15, 2000.

(51) Int. Cl. G06K 9/00

(52) U.S. Cl. 382/137

(57) ABSTRACT

An automated transaction machine includes a scanner configured to receive a bill or coupon. The coupon is processed by application of connected component analysis, segmentation, coupon matching, and data extraction to determine an associated vendor and customer account information. This information is used to complete a payment transaction.

### FIELD OF THE INVENTION

The present invention relates generally to methods of automatically recognizing a document and more specifically to recognizing a document used in the sale or purchase of goods and services, commonly referred to as a bill or a coupon.

### BACKGROUND OF THE INVENTION

In their efforts to find better ways to manage and support the increasing demand for products and services at financial institutions, the banking industry has turned to the implementation of automated systems that enable faster transaction processing while providing customers with a broader and more accessible variety of services on a “self-service” basis. The flexibility of extended branch hours and multiple transaction processing available at most automated teller machines (“ATM's”) have dramatically altered the way in which customers interact with banks, and have become an additional and almost indispensable convenience to everyday living. Recent improvements to ATM-related machines will allow a customer to pay a bill using a debit or credit card. The bill is scanned and automatically recognized. The customer can then make payment by providing a debit or credit card.

Although various recognition algorithms may be used to identify the product or service provider, the customer and the amount associated with a bill or coupon, invariably such systems include some degree of error. That is, virtually any system will make some errors in identifying the product or service provider, the customer and the amount associated with a bill or coupon. The possibility for errors may contribute to the unwillingness of banks and other financial institutions to offer automated bill payment on a large-scale basis. Likewise, the uncertainty of these transactions may feed consumer apprehension in using such systems. Accordingly, a more robust system is desired.

### SUMMARY OF THE INVENTION

According to one aspect of the invention a customer enters a paper bill into a scanner. The resulting image data is provided to an associated computer. The computer extracts prominent features from the image in order to determine (1) the company that issued the bill, and (2) the customer's account number and the amount to pay. The first goal is a one-to-many matching problem. The system determines the closest match between the input coupon and a library of coupons each associated with a company. If the coupon does not match any coupon in the database, it returns the paper bill to the customer and alerts the customer that the paper bill does not match any template in its library. Thus, the computer performs both matching and authentication. The second goal is an optical character recognition (OCR) problem. After a bill type has been recognized, a customer field and an amount field may be extracted. The text in such fields are provided to an OCR program that transforms the pixel data into machine-readable code.

According to another aspect of the invention, after a bill or a number of bills from a customer have been recognized, the customer is provided with a number of payment options. These include any combination of credit card, debit card, smart card, cash, check or other means of payment. If the customer elects to pay by cash, check or other paper document, the customer enters the paper document into a scanner. The paper document is identified and authenticated. For example, in the case of a check, the computer isolates the amount field as well as the unique account identifier. The text in such fields are provided to an OCR program that transforms the pixel data into machine-readable code.

In the case of cash, the paper bill is accepted by a separate scanner and associated authentication processor. The authentication processor performs various checks on the paper bill to determine both its authenticity and denomination. The result is passed to the computer so that the customer may be credited a corresponding amount. This payment, in turn, may be applied by the customer against any outstanding bills.

According to another aspect of the invention, a method of operating an automated transaction machine includes recognizing a coupon by scanning the coupon to generate an electronic representation. Segments of the electronic representation are compared with a defined category of patterns. Any segments that match one of the patterns is eliminated as noise. Connected segments are identified within the electronic representation. A barcode search is applied to the connected segments and any additional segments proximate thereto to determine whether the connected segments form a portion of a barcode sequence. If so the alphanumeric characters associated with the barcode sequence are determined. An optical character recognition search is applied to the connected segments and any additional segments proximate thereto to determine whether the connected segments form a portion of a text string. If so, the alphanumeric characters associated with the text string are determined. A table search is applied to the connected segments to determine whether the connected segments form any portion of a table. If so the boundaries and position of the table on the coupon are determined. The alphanumeric characters associated with the barcode sequence, the alphanumeric characters associated with the text string, and the boundaries and position of the table are compared with a database of coupon data to determine whether the electronic representation matches a coupon type in the database of coupon data.

According to a further aspect of the invention, connected segments are run-length encoded so that each row of is represented by a plurality of start and end points that represent the start and end of a continuous run of elements. The start and end points of adjacent rows are compared to determine whether any start or end points fall between the start and end points of the adjacent rows.

According to a further aspect of the invention, segments of the electronic representation are compared with a defined category of patterns. The central bit of the segments are eliminated when the comparison generates a match, provided that the elimination of the central bit will not disconnect otherwise connected components.

According to a further aspect of the invention, the match is detected if the location and value of the barcode sequence or the character strings match an entry in the listing of vendor data.

According to a further aspect of the invention, a customer account and an account balance are determined after determining a coupon type. The customer account and the account balance are read from the table of coupon data.

According to another aspect of the invention, a method of identifying a vendor, a customer and an account balance based upon the representation of a coupon begins by grouping image data into a plurality of interconnected segments. The interconnected segments are then grouped to form objects of various types that include text lines, barcodes and OCR lines. Barcode recognition is applied to the interconnected segments to detect any barcode character sequences. Optical character recognition is applied to the interconnected segments to determine an optical character sequence. Text character recognition is applied to the interconnected segments to determine a text character sequence. A table stores the barcode character sequence, the optical character sequence, and the text character sequence. At least one of the barcode character sequence, the optical character sequence, and/or the text character sequence are compared to a database of vendor data to detect a match that determines a vendor. An expected location of a customer identifier and an expected location of an account balance are determined based upon the vendor. The customer identifier and the account balance are determined based upon the expected location.

According to a further aspect of the invention, a plurality of bounding boxes are determined, each of which define the limits of one of the plurality of interconnected segments.

According to a further aspect of the invention, the bounding boxes are compared to a plurality of thresholds to identify interconnected segments comprising noise and to identify interconnected segments comprising an OCR character sequence.

According to another aspect of the invention, the automated transaction machine is implemented on a computer system especially suitable for determining vendor, customer and account data associated with a coupon. The computer system includes a scanner, a card acceptor, and a network connection.

### BRIEF DESCRIPTION OF THE DRAWINGS

FIG. 1 is a block diagram showing one preferred system for determining a coupon type and extracting relevant fields from the coupon. The system includes a scanner 112, a database of coupon data 116, and a coupon engine 114. The coupon engine 114 compares a coupon image received from the scanner 112 with the database of coupon data 116 to determine its type and to extract the relevant fields.

FIG. 2 is a block diagram showing one preferred system for establishing the database of coupon data 116.

FIG. 3 is a block diagram showing further details of one preferred coupon engine. It includes a preprocessor 310, a segmentator 312, a match engine 314, an extraction engine 316, and a post processor 318.

FIG. 4 is a block diagram showing further details of one preferred preprocessor 310.

FIG. 5A is a block diagram showing one preferred method of performing segmentation of the coupon image data.

FIG. 5B is a block diagram showing one preferred database structure suitable for use with method of segmentation of FIG. 5A.

FIG. 6A shows one example of a black-and-white scanned image of a coupon.

FIG. 6B shows the example coupon of FIG. 6A along with one preferred connected component analysis associated therewith.

FIG. 6C shows the example coupon of FIG. 6A along with one preferred segmentation analysis associated therewith.

FIG. 7A shows one preferred connected component table generated by performing connected component analysis on the coupon image of FIG. 6A.

FIG. 7B shows one preferred segmentation table generated by performing segmentation on the coupon image of FIG. 6A.

FIG. 8 is a block diagram showing one preferred method of determining the coupon type based upon a comparison with a coupon database.

FIG. 9 shows one preferred set of patterns that are applied to a coupon image in the preprocessor 310 of FIGS. 3 and 4 to reduce noise in the coupon image.

FIG. 10 is a block diagram showing a computer system suitable for implementing the preferred system of FIG. 1.

### DETAILED DESCRIPTION OF THE PREFERRED EMBODIMENTS

In one preferred embodiment of the invention, a paper bill or coupon is scanned and compared to a database of coupon data. The comparison is used to determine the coupon type and associated vendor. After making this determination, various fields of interest are extracted from the coupon such as account name, account balance, billing address, etc.

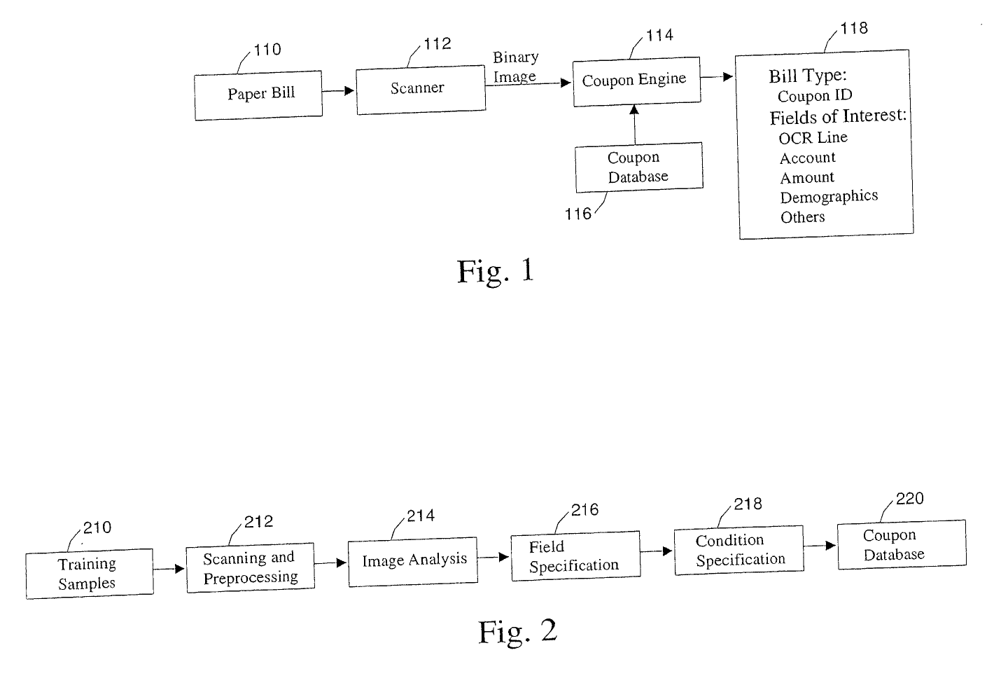

Turning to FIG. 1, the process of identifying a coupon and extracting various fields is further described. At block 110, a customer presents a coupon. Typically, the coupon includes various forms of data such as a barcode, an OCRA text line, a logo, text, and others. These various forms of data are used to determine the vendor that issued the coupon, as well as an associated customer account identifier, an account balance, and related account data.

At block 112, the coupon is passed through a scanner such as are widely available commercially. The scanner passes the coupon over an opto-electronic transducer to generate an electronic representation of the coupon. Preferably, the scanner is configured to provide a black-and-white image of the coupon, that is a binary bitmap of the coupon. In practice, 200 dpi resolution is sufficient for most coupon types and preferred because the relatively low resolution reduces data processing requirements. Nonetheless, some barcode images require finer scanning to distinguish adjacent lines. When coupons with fine barcodes are used, the resolution is set to 300 dpi, or the lowest resolution capable of resolving the lines of the barcode or other feature of the coupon.

At block 114, information is extracted from the electronic representation of the coupon. For example, the size of the coupon is determined. Various data fields are identified, such as barcodes, OCR lines, text lines, table boundaries, and others. As appropriate, the symbols in these fields are passed to a recognition program that decodes the symbols into alphanumeric strings. These are compared to the coupon database 116 to determine whether the incoming coupon matches the type of an entry in the coupon database 116. The criteria for making this determination are further described below. Where the coupon generates a match, the coupon database will identify certain areas of interest in the coupon, such as an OCR line with an associated account number and balance due.

On many coupons, the same data is repeated in multiple formats. For example, the customer account number may be listed as a text string and as a barcode or OCR line. If one generates an error, the other may be used as an alternative source of information. Likewise, the two may be checked against each other to ensure that no errors were made in converting the underlying image object into an alphanumeric string.

Finally, at block 118, the results of the coupon analysis are provided. Typically, this includes a coupon ID that identifies the vendor. Where a particular vendor uses more than one coupon layout, then more than one coupon ID will be associated with the particular vendor. The results will also include a number of additional fields that vary by coupon type. In most instances, these will include an OCR line that includes the vendor's ID, an account number, an amount due, and name and address information.

Turning to FIG. 2, the process of establishing the database of coupon data 116 is described. The process begins at block 210 by providing a number of sample coupons from the same vendor having the same type. Where a vendor uses more than one coupon type, the different types are added in separate sessions. Preferably, at least ten sample coupons are provided.

Then, at block 212, the sample coupons are scanned and processed to remove skew and noise. The output provides a black-and-white bitmap for each of the underlying coupons. This data is used to establish the location, size and variation of the relevant fields.

Next, at block 214, the bitmap is processed to determine the location and size of various fields. This processing includes both connected component analysis and segmentation, which are further described below. The result is a listing of the type of elements in the coupon that is automatically generated by software engines. The listing includes position and type information for each element of the coupon image.

Next, at block 216, a user specifies fields of interest. For example, a particular coupon type will include an account name and number, an amount due, and an issue or due date. The user may select fields that should be extracted from a coupon image for processing payment. The selected fields (also termed fields of interest) will depend upon the information provided on the coupon and upon the processing needs of the vendor issuing the coupon.

For example, a particular vendor may include an OCR line along the bottom of their coupons. This OCR line may include the account number and amount due. For this coupon, the user would specify the expected location of the OCR line along with the format for receiving the account number and amount due. When this type of coupon is identified by the coupon engine, the field of interest information is used to extract the account number and amount due.

Next, at block 218, a user specifies the set of sufficient conditions for identifying a coupon. For example, some vendors include a unique reference number as part of an OCR line to identify themselves. In such cases, an OCR line containing the unique reference number may be sufficient to identify a particular coupon type and associated vendor. In other cases, a barcode, text line, coupon layout or even a logo may be used to identify the coupon and associated vendor. The user specifies which of these elements or combination of elements shall be conclusive in determining the type of a coupon. The user may specify more than one condition for making this determination. For example, where a coupon includes a barcode and also includes the vendor's name and logo the user may specify that the vendor's barcode sequence will prove conclusive in determining the vendor. If a barcode match is not found, possibly because of a damaged coupon, the vendor's name and logo will prove conclusive in determining the vendor. These conditions are specified by the user.

Next, at block 220, the field specification and condition specification are saved in the coupon database. This database is used to determine a coupon type and to extract fields of interest. This process is further described below.

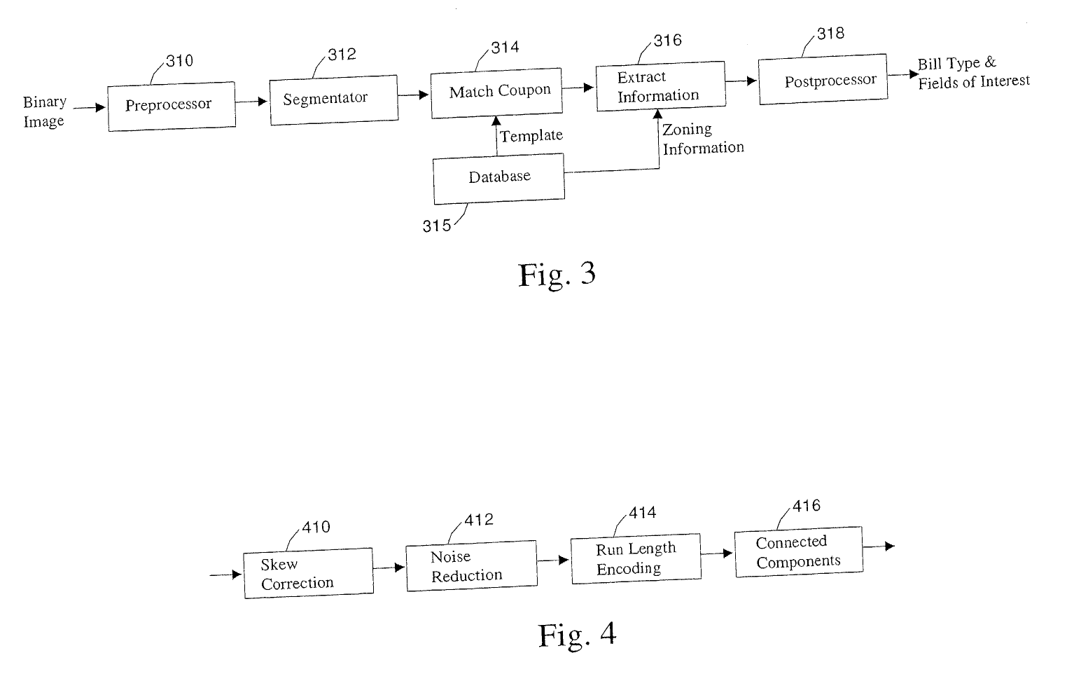

Turning to FIG. 3, one preferred method of operating a coupon engine, shown as block 114 of FIG. 1 is described. The process begins at block 310 where the binary image data is received from a scanner. Here the data is preprocessed to reduce noise and to reformat the bit data information into a map of connected components. A connected component is any combination of one or more bits that are connected to one or more other bits. For example, an individual letter in a text line consists of a group of interconnected bits. The connected component analysis will identify that group of bits together. The connected component analysis also identifies the coordinates of the minimal bounding box for the connected components. This provides the coordinates for the upper, lower, left and right boundaries of the bounding box.

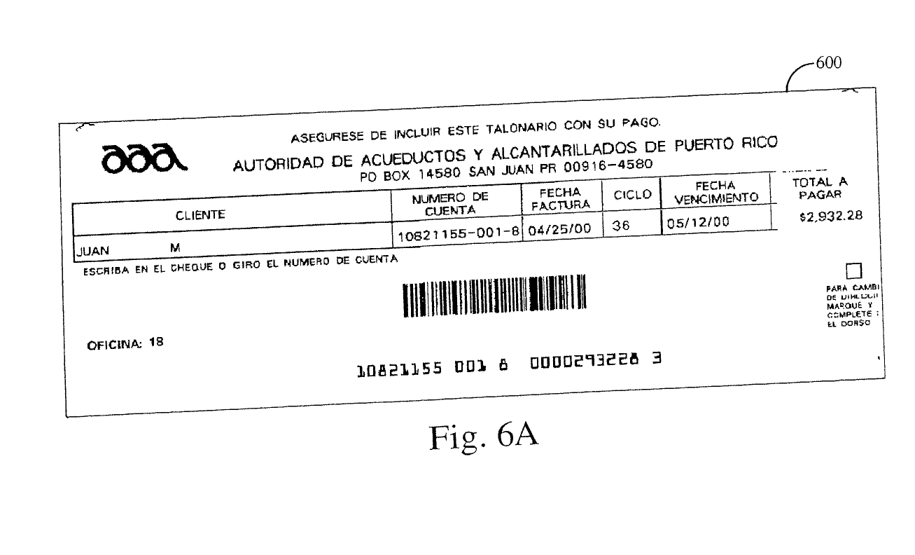

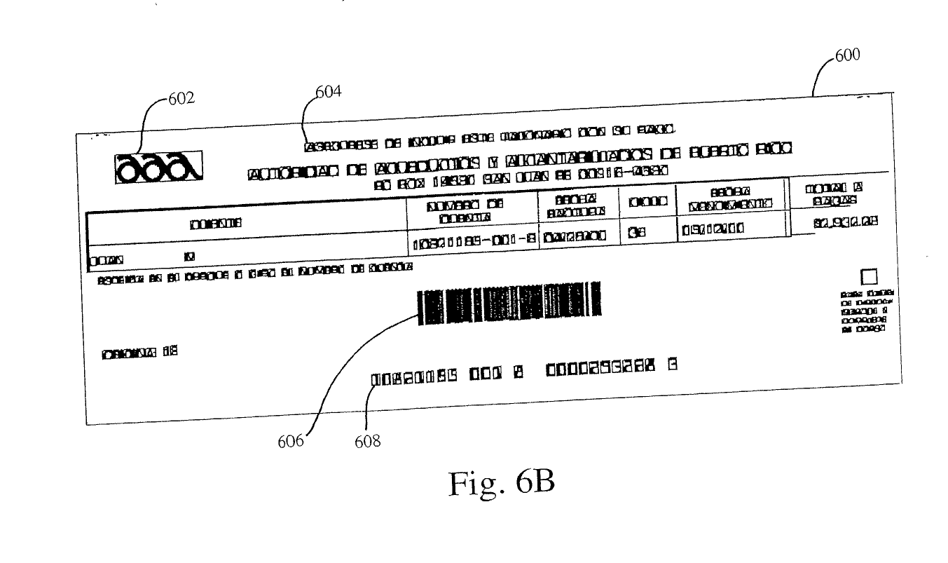

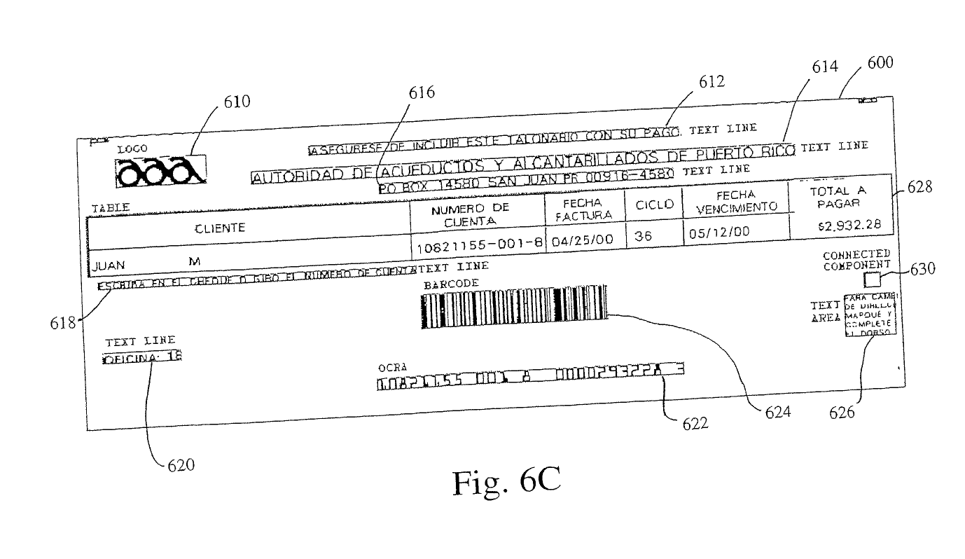

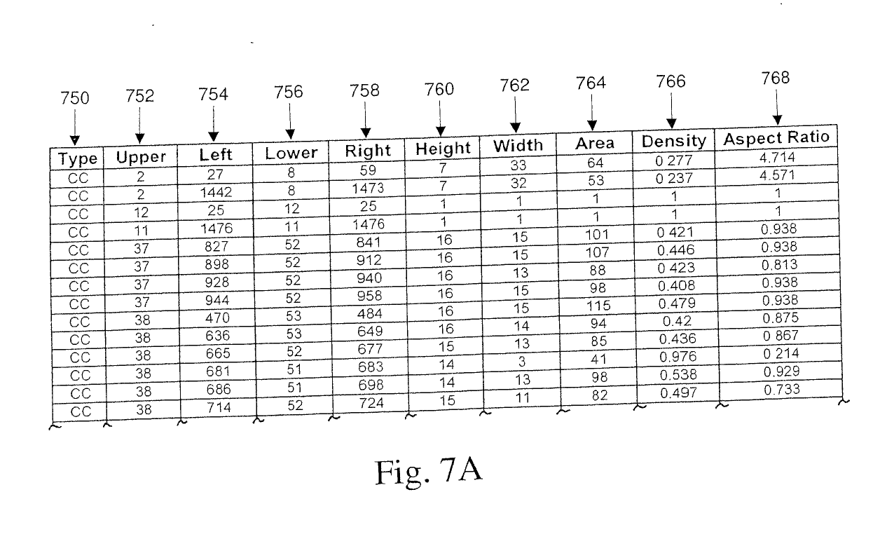

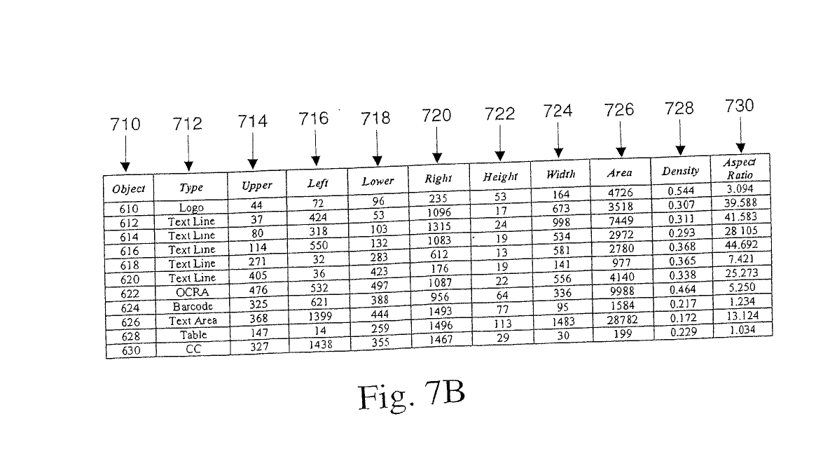

The preprocessing is further described below with reference to FIG. 4. A coupon image shown divided into bounding boxes each surrounding one connected component is described below with reference to FIG. 6A. The associated table of bounding box information is described below with reference to FIG. 7A.

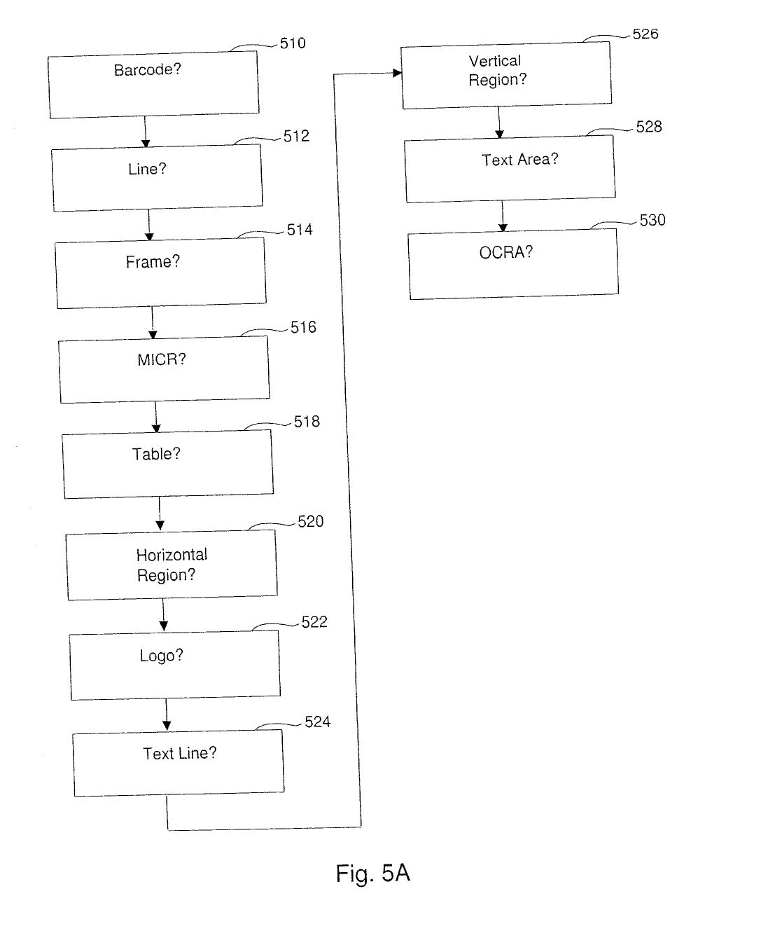

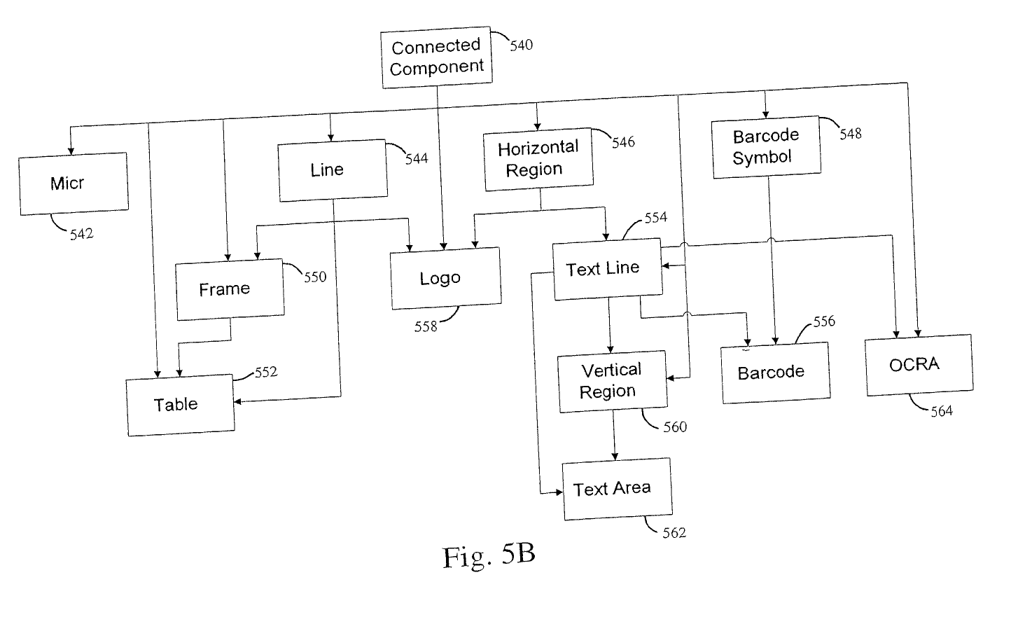

After completing the connected component analysis, the data is passed to a segmentator at block 312. The segmentator operates upon the connected components and associated bounding boxes to determine their type. Preferably, twelve symbol types are identified. These include: (1) barcode, (2) line, (3) frame, (4) MICR line, (5) table, (6) horizontal region (or text word), (7) logo, (8) text line, (9) vertical region, (10) text area, (11) OCR line, and (12) connected component types. Each connected component is classified into one of these types depending upon its underlying characteristics. These components are classified in accordance with rules that are applied to the connected components and described below with reference to FIGS. 5A and 5B.

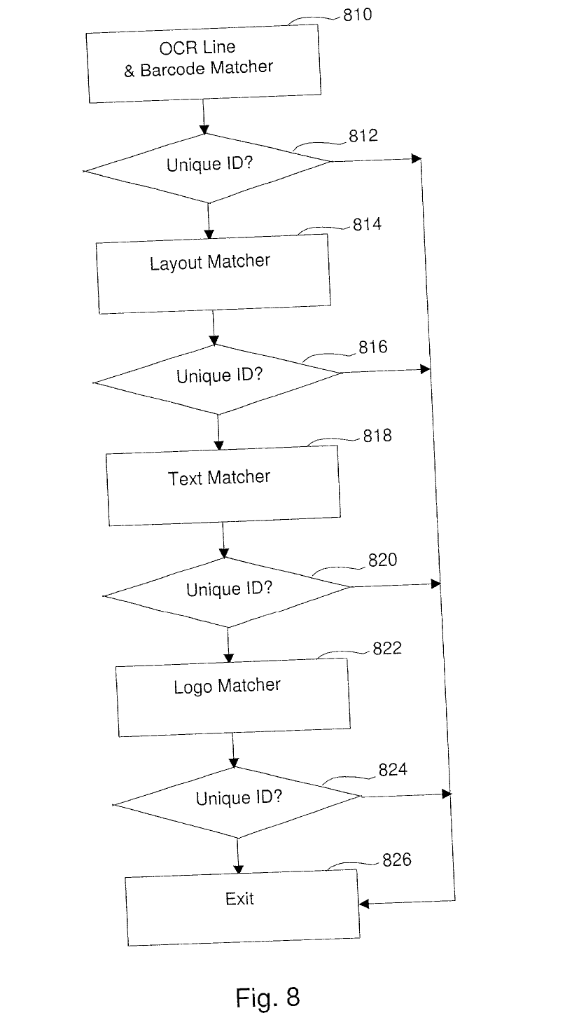

Next, at block 314, the information from the segmentation process is used to determine the coupon type. Specifically, the information from the segmentation process is compared with information from the coupon database 315. If the information from the coupon matches a set of conditions in the coupon database 315 the coupon type is determined. Otherwise, the coupon is rejected as not an acceptable coupon type. The process of generating a match is further described below with reference to FIG. 8.

After identifying the coupon type, the process proceeds to extract customer information including account number, amount due and similar information, at block 316. The coupon database 315 identifies the areas or zones where this information may be found. These areas are provided to the appropriate recognition engine for processing. For example, where the coupon database 315 directs extraction of a customer name from a text line, the identified area is passed to the optical character recognition engine. There the text is processed and the customer name returned as a character sequence. After extracting the desired fields, the process proceeds to perform post-processing operations at block 318.

In practice, the recognition engines achieve a high degree of accuracy. Nonetheless, errors may occur during the process of extracting data. Post-processing is applied to minimize these errors. For example, spell checking, zip code checking and other standard checks can be applied as post-processing at block 318.

After completion of the post-processing, the resulting coupon type and fields of interest are provided by the computer. This information is used to process the coupon.

Turning to FIG. 4, one preferred preprocessor suitable for use as the preprocessor 310 of FIG. 3 is described. The preprocessor includes a skew correction block 410, a noise reduction block 412, a run length encoding block 414, and a connected components block 416. Document skew results from imperfections in the scanning process. Preferably, the skew correction is performed in the scanner (shown as scanner 112 in FIG. 1). However, if the scanner does not provide this functionality, then it is implemented in the preprocessor 310.

Next, noise reduction is applied at block 412. Preferably this includes the morphological operations of erosion and dilation. This reduces or eliminates noise in the image, which is introduced by the scanning process and by background design patterns present in some coupons.

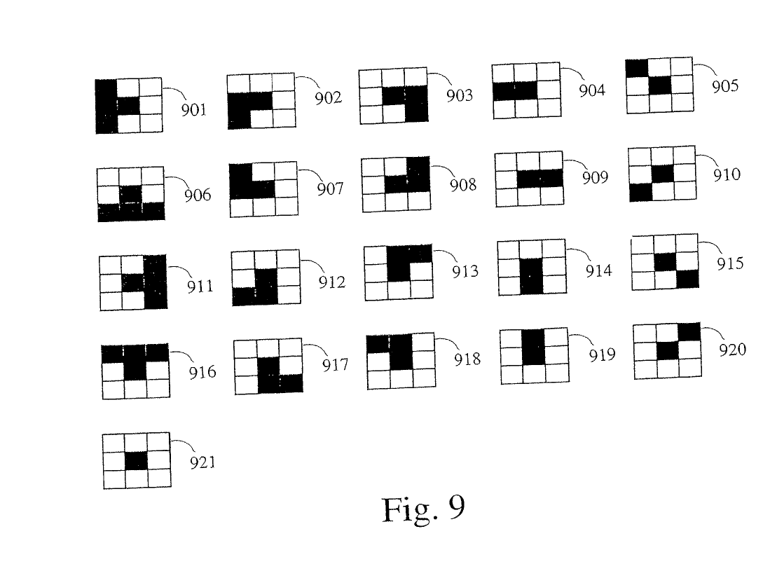

The morphological erosion is performed by comparing three by three image segments with a predefined group of patterns. If an image segment matches the pattern, then the center bit of the image is treated as noise and eliminated. One preferred set of templates used in this operation is shown in FIG. 9.

Turning briefly to that figure, templates 901-921 are used in the erosion process. Although the templates are shown graphically, they may also be represented as a string of bits. For example, template 901 may be represented as: [100,110,100], template 902 may be represented as: [001,110,100], and so on.

When applying the templates 901-921, a bit is first detected. The templates are applied by aligning the center of the template with the detected bit. The center bit for each template is always black. That is, using the above notation, the templates all follow the form: [XXX,X1X,XXX], where an “X” denotes a surrounding bit, and the “1” identifies the center bit. Since the center bit is always set and always compared to a bit that is also set, the comparison between these bits will always generate a match. Accordingly, after detecting a bit, the template is compared only to the surrounding bits to determine a match. This provides a computational benefit as one fewer comparisons are made.

The templates 901-921 are chosen to reduce noise and at the same time to avoid the possibility that a connected component is split by the application of the templates. For example the template [101,010,000] is not included even though the template 916, [111,010,000] is included. The template [101,010,000] would act to split an otherwise connected component.

Returning to FIG. 4, after performing noise reduction, the remaining data is run-length encoded. Since the image typically includes long stretches of white space. Each bit is not encoded, rather the transition from a white bit to black bit is encoded. For coupon documents, this tends to reduce the bit requirements. Thus, the run-length encoding algorithm traverses the image row-wise and encodes continuous runs of pixels storing only its row and the columns where the run starts and ends.

Next, the run-length encoded image data is provided to a connected component block 416. Any two adjacent runs that overlap or any two adjacent runs that end and begin within one bit are grouped as a connected component. For example a run in the first row beginning at pixel 10 and extending to pixel 20 would be joined with a run in the second row beginning at pixel 15 and extending to pixel 25. Likewise, a run in the third row beginning at pixel 10 and extending to pixel 20 would be joined with a run in the fourth row beginning at pixel 21 and extending to pixel 31. Thus, when applying this algorithm to a pixel, another pixel is adjacent thereto if it lies in any of the eight surrounding locations (also termed eight-connected). One preferred method of determining the connected components is described in “Data Structures and Problem Solving using C++,” M. A. Weiss, 2^{nd} Ed., Addison Wesley Longman, Inc., Reading, Mass., 2000, at pages 845 through 863, which is incorporated herein by reference.

Turning to FIG. 5, the process of applying the segmentation analysis is further described. The segmentation analysis applies rules and conditions as explained below to the connected components to group them into the twelve symbol types. Again, these include: (1) barcode, (2) line, (3) frame, (4) MICR line, (5) table, (6) horizontal region (or text word), (7) logo, (8) text line, (9) vertical region, (10) text area, (11) OCR line, and (12) connected component types. Where specific reference is made to a pixel threshold or comparison, the scanning resolution is set to 200 dpi. For other scanning resolutions, the pixel thresholds are simply adjusted proportionally.

Beginning at block 510, the segmentator searches the connected components to find a candidate for a barcode. The search begins by finding a connected component having a linear shape such as the individual lines of a barcode. Specifically, the segmentator searches for a connected component having a density greater than 0.5 and an aspect ratio less than 0.25 or greater than 4. The density is defined as the number of (black) pixels in the connected component divided by the number of pixels in the bounding box associated with the connected component. The aspect ratio is defined as the width divided by the height. The height and width are determined by the bounding box associated with a connected component.

After finding one connected component that meets these conditions, the segmentator tries to extend the barcode area by finding another line adjacent to the first line that also meets the conditions for a barcode element. After finding such an element, the overlap between the two is determined. At least eighty percent of the first line must overlap the second line, and vice versa. For example, suppose that the first line begins at an uppermost pixel of 320 and extends down to a lowermost pixel of 380. Further suppose that the second line begins at an uppermost pixel of 325 and extends down to a lowermost pixel of 388. Then the length of the first line is 61 pixels. The number of pixels overlapping the second line is from 325 to 380 or 56 pixels. Thus the ratio of overlap compared to the total length of the first line is 0.92. Similarly, the length of the second line is 64 pixels. The number of pixels overlapping the first line is also from 325 to 380 or 56 pixels. Thus the ratio of overlap compared to the total length of the first line is 0.88. Since both of these ratios exceed 0.8, the barcode area is extended to encompass the second line.

This process of extending the barcode area is repeated until no other connected components satisfy the above conditions. When adding more barcodes, the overlap conditions are applied to between the nearest lines. Thus the overlap of a third line would be compared against the second line, and so on.

When no other connected components satisfy the above conditions, the overall barcode area is tested to ensure that the group properties are credible. Specifically, the barcode must have more than five connected components as elements. If it meets this condition, the area is classified as a barcode and its position and other properties are saved in a table. If it does not meet this condition, it is disqualified as a barcode and the individual connected components are not classified as a barcode area. The segmentator then searches for other candidate connected components to form the first element of a barcode area. If one is found, the above process is applied to that element.

Although a rare occurrence, some coupons may include a second barcode. In such cases, after finding one barcode area, the segmentator searches for other candidates and applies the above described process for extending the barcode area and determining its credibility. When no additional barcodes areas are found, the segmentator ends this step.

Next, at block 512, the segmentator searches the connected components to find any individual lines. To qualify, a connected component must meet one of three criteria. First, the width must be greater than 14 and the height less than or equal to 4 pixels. Second, the width must be less than or equal to 4 and the height must be greater than 34 pixels. For the second condition, a larger height is required to avoid classifying an “I” or an “1” as a connected component. Third, the width must be greater than or equal to 60 and the height must be less than or equal to 10 pixels.

If any connected components meet one of these requirements, it is classified as a line. In some cases, a coupon may be folded or include imperfections in the printing process that break the continuity of a single line. Accordingly, after finding a line, the segmentator applies further conditions that may extend the line to other nearby line segments. This process is applied only to lines detected by the first or second condition above as these are narrower and more susceptible to breaks.

Specifically, for a line detected by the first condition the segmentator searches for other connected components also having a height less than or equal to 4. If any meet this condition, then the horizontal and vertical distance between the two connected components is compared. For this comparison, the pixel locations that define the associated bounding box are used. The horizontal distance, Dₕ is defined as follows:

Dₕ=Max(BB1.Left,BB2.Left)−Min(BB1.Right,BB2.Right).

In this formula, BB1 refers to the first bounding box and BB2 refers to the second bounding box. Left refers to the pixel location of the left side of the bounding box and Right refers to the pixel location of the right side of the bounding box.

By way of example, the horizontal distance between two bounding boxes, each associated with a different connected component, will be calculated. The first bounding box has a left side at 72 and a right side at 102. The second bounding box has a left side at 105 and a right side at 125. Thus, BB1-Left is equal to 72, BB2-Left is equal to 105, BB1-Right is equal to 102, and BB2-Right is equal to 125. Applying the above formula yields a horizontal distance of 3 pixels.

The vertical distance, Dᵥ, is defined as follows:

Dᵥ,=Max(BB1.Upper,BB2.Upper)−Min(BB1.Lower,BB2.Lower).

In this formula again, BB1 refers to the first bounding box and BB2 refers to the second bounding box. Upper refers to the pixel location of the upper side of the bounding box and Lower refers to the pixel location of the right side of the bounding box.

By way of example, the vertical distance between two bounding boxes, each associated with a different connected component, will be calculated. The first bounding box has a upper side at 80 and a lower side at 84. The second bounding box has an upper side at 81 and a lower side at 85. Thus, BB1-Upper is equal to 80, BB2-Upper is equal to 81, BB1-Lower is equal to 84, and BB2-Lower is equal to 85. Applying the above formula yields a vertical distance of −3.

Again, after detecting a line that meets the first condition (width greater than 14 and height less than or equal to 4 pixels) the segmentator searches for other connected components also having a height less than or equal to 4. If any meet this condition, then the horizontal and vertical distance between the line and the connected component is compared. If the horizontal distance is less than 30 and the vertical distance is less than 4, then the line is extended to include the connected component.

After detecting a line that meets the second condition (width less than or equal to 4 and height greater than 34, the segmentator searches for other connected components also having a width less than or equal to 4. If any meet this condition, then the horizontal and vertical distance between the line and the connected component is compared. If the horizontal distance is less than 4 and the vertical distance is less than 30, then the line is extended to include the connected component.

Additional connected components may be added to a line in the same manner. For the above calculations of horizontal and vertical distance, the bounding box of the line is used with the bounding box of any additional connected components.

After detecting a line that meets the third condition (width greater than or equal to 60 and height less than or equal to 10 pixels), the segmentator does not attempt to extend the line. In this case, the line is wider and less susceptible to various forms of interruptions.

After detecting and, if applicable, extending a line, the segmentator continues to search for any other connected components that may form a second line. The same extension process is applied to those additional lines.

Next, at block 514, the segmentator searches for frames. Generally, a frame is defined by a set of lines along its outer boundaries, and a number of lines that divide the frame into cells. A frame typically has a low density of pixels. That is, it is composed primarily of white space. A frame will also include a number of lines. Thus, if a histogram or projection is applied to the frame image, it will return a number of sizable peaks that correlate with the lines forming and dividing the frame.

The segmentator begins the search for a frame by applying two sets of conditions to the remaining connected components. First, the width must be greater than 66, the height must be greater than 33 pixels, and the density must be less than 0.3. Second, the width must be greater than 133, the height must be greater than 66 pixels, and the density must be less than 0.5. If a connected component meets either of these conditions, it is classified as a frame provided it also meets the credibility conditions discussed below.

In addition, a connected component having a width and a height greater than 50 pixels, and a density of less than 0.3 will initially qualify as low density area. The segmentator applies a projection to the low density area. The projection sums the pixels in a row (or column) to provide a density function. In this projection, a horizontal or vertical line will produce a noticeable peak.

In many instances, however, the pixels that form a line of a table will be skewed or rotated across more than one rows or columns. To insure that these lines provide large peaks, a further mapping algorithm is applied. For a line in a given column, the mapping algorithm compares the top-most bit to the top-most bit of the adjacent columns. If the adjacent columns include a top-most bit that is higher, then the line is extended upward to that bit. In addition, for that same line, the mapping algorithm compares the bottom-most bit to the bottom-most bit of the adjacent columns. If the adjacent columns include a bottom-most bit that is lower, then the line is extended downward to that bit. After extending the line in the above fashion, the sum of the bits are totaled for the column. This total is used as the result of the projection for that column.

The projection is run in both the x and y directions, and the above-described process is applied to the rows as well. In typical applications, a frame will return projections having sizable peaks that correspond with the lines of the frame. A peak is defined as any element that is fifty percent or greater of the maximum possible value. For example, for a bounding box that is 100 pixels high, after applying the above projection, any resulting element that is 50 or greater will qualify as a peak.

If the histogram shows a relatively small fraction of peaks (10% or less in either the x or y directions), it is likely to include a line and to form at least a portion of a frame. If the connected component meets this further condition, then it is also classified as a frame subject to a credibility check.

After detecting a frame, the segmentator attempts to extend it to other lines and connected components. The segmentator will add a line if it meets any of three conditions. First, if the bounding box of the frame includes the line, then the line will be included with the frame. Second, if the bounding box of the frame overlaps with the bounding box of a line, then the line will be included with the frame. Third, if the line is relatively near to the frame it will be added to the frame.

In regard to the third condition, a line is relatively near if it meets one of two conditions. First, it is relatively near if the height of the line is less than or equal to 4, the horizontal distance between the bounding box of the frame and the bounding box of the line is less than 133 and the vertical distance between the bounding box of the frame and the bounding box of the line is less than 4. Second, it is relatively near if the width of the line is less than or equal to 4, the horizontal distance between the bounding box of the frame and the bounding box of the line is less than 4 and the vertical distance between the bounding box of the frame and the bounding box of the line is less than 133.

After adding lines and connected components as set forth above, the segmentator will proceed to search for additional frames. This search is performed in the same manner as set forth above. If any additional frames are found, the segmentator will test to determine whether two separate frames should be joined as one. Two frames will be joined if they meet one of two conditions. First, if the frames overlap, then they will be joined. Second, if the frames are near, then they will be joined.

Two frames are near if they meet one of two conditions. First, two frames are near if the horizontal distance between their bounding boxes is less than or equal to 0 and the vertical distance between their bounding boxes is less than or equal to 5. Second, two frames are near if the horizontal distance between their bounding boxes is less than or equal to 5 and the vertical distance between their bounding boxes is less than or equal to 0.

After detecting frames, either alone or as a combination of overlapping or near frames, the segmentator applies a credibility test. The credibility test operates by evaluating the projections of the frame. The frame must include at least two vertical peaks and two horizontal peaks. If a frame meets these conditions, it is finally classified as a frame. If not, its elements are released as a collection of lines and connected components.

Next, at block 516, the segmentator searches for MICR lines. MICR lines include a number of special characters that are useful in making an initial determination. These special characters are shaped as small solid squares and rectangles. In addition to the special characters, MICR also use numbers having a relatively fixed height. These characteristics are used to identify an MICR line.

Specifically, the following six conditions are used to make an initial identification of MICR characters: (1) the width is greater than or equal to 6 and less than or equal to 10, and the height is greater than or equal to 6 and less than or equal to 10; (2) the width is greater than or equal to 4 and less than or equal to 6, and the height is greater than or equal to 14 and less than or equal to 18; (3) the width is greater than or equal to 1 and less than or equal to 4, and the height is greater than or equal to 14 and less than or equal to 17; (4) the width is greater than or equal to 6 and less than or equal to 10, and the height is greater than or equal to 8 and less than or equal to 12; (5) the width is greater than or equal to 2 and less than or equal to 4, and the height is greater than or equal to 8 and less than or equal to 12; and (6) the width is greater than or equal to 4 and less than or equal to 7, and the height is greater than or equal to 8 and less than or equal to 12. If a connected component meets any one of these conditions and its density is greater than 0.75, then it qualifies as a special character.

After detecting these special characters, the segmentator begins with one and attempts to extend it to include other connected components that qualify as numerical characters. Specifically, the segmentator searches for connected components having a height of greater than or equal to 20 and less than or equal to 26. If any are found, the vertical distance between the bounding box of the MICR line and the connected component are compared. If the vertical distance is less than 0, then it is on the same line. Accordingly, it is added as part of the MICR line. Additional connected components are added in the same fashion. Likewise, other special characters as identified above are added to the MICR line if the vertical distance between the MICR line and the special character is less than 0.

The segmentator applies the above conditions to extend the MICR line until it has exhausted possibilities for further extentions. It then checks the credibility of the MICR line. The MICR line must meet the following three conditions. First, it must have eight or more elements, where each connected component (including the special characters) included therewith counts as an element. Second, it must have two or more special characters. Third, the number of special characters divided by the total number of connected components (including connected components) must be less than 0.5.

If the MICR line meets these conditions, it is classified as such. Otherwise the elements are released. Typically, a coupon will include only one MICR line. Nonetheless, it is possible to include more and in such instances, the segmentator will check for the possibility of more than one MICR line and determine its credibility as described above.

Next, at block 518, the segmentator creates tables. A tables is simply a frame that is extended to include any lines or connected components that lie within the frame.

Next, at block 520, the segmentator searches for word (or horizontal) regions. A word region typically includes a series of alphanumeric characters. Typically, the characters forming a word will exceed a certain height, be relatively closely spaced and substantially aligned along a horizontal line.

To make this determination, the segmentator begins by testing the height of the remaining connected components. Any connected component having a height greater than or equal to five initially qualifies as a word region. After identifying a first element, the segmentator attempts to extend the word region.

If an adjacent connected component has a density greater than 0.1, the segmentator proceeds to make a number of additional checks. Specifically, the segmentator checks that the horizontal distance between the bounding box of the word region and the bounding box of the next connected component is less than 15 pixels. The vertical overlap between the word region and the connected component is also checked. In practice, the vertical size of the characters may vary, especially between capital and lower case letters. Here the amount of overlap the word region has with the connected component and the amount of overlap the connected component has with the word region is calculated as a fraction of its total height. This provides to measures of overlap. The larger measure must exceed 0.7, as will be the case for most lower case letters that follows a capital letter. The smaller measure must exceed 0.3, as will be the case for most capital letter that proceed a lower case letter. Most letters of the same case will have nearly complete overlap.

To accommodate the relatively rare case where a tall letter such as an “1” is followed by a letter that extends below the bottom of the related text, such as a “y,” a further condition is applied. Specifically, if the difference in the bottom of the candidate connected component is greater than 5 pixels, then the overlap conditions are relaxed. Specifically, the overlap must be greater than 0.4 for both the smaller and larger measure.

When a connected component meets these additional conditions, it is added to the word region. When no other connected components remain that will satisfy the above conditions, a credibility check is performed. The credibility check counts ensures that the number of elements exceeds one. If so the group of connected components are classified as a word region.

Next, at block 522, the segmentator searches for logo areas. A logo area, as the name implies, is an area of a coupon that includes a company logo. Such a logo may include virtually any feature. A relatively small number of features are typical. For example, a logo often includes large text letters forming the vendor's name or an abbreviation. Also, the logo area often includes lines. In almost every case, a logo is substantially larger than other elements of the coupon.

The segmentator begins by searching the connected components and word regions for any that have a height greater than 50. If any are found, the segmentator attempts to extend the logo area. The extension is applied to any connected components, lines, or horizontal regions that have a horizontal distance less than 0 or a vertical distance less than zero. In addition these must have a Euclidean distance between the center of the logo and their respective center that is less than a threshold. The threshold can be set and will vary depending upon the size of the largest logos that will be used in the system.

Next, at block 524, the segmentator attempts to find text line areas. These are composed of word areas and connected components. Generally, the words that form a text line will vertically overlap and are spaced relatively close together.

The segmentator begins by searching for horizontal region that are adjacent to other horizontal regions or connected components. Specifically, a text line will be extended from a first horizontal region to include another horizontal region or a connected component by determining the horizontal distance between the two objects. If that distance is less than twice the height of the text line, then the vertical overlap between the two objects is determined. Here the vertical overlap of the text line as compared with the horizontal region or connected component must be greater than 0.7. Likewise, the vertical overlap of the horizontal region or connected component with the text line must be greater than 0.7. If the horizontal region or connected component meets these criteria, it is added as part of the text line. Otherwise it is released and may be used to form other objects.

After establishing a first text line, the segmentator continues to check any remaining horizontal regions to determine whether they may form a portion of a text line.

Next, at block 528, the segmentator searches for vertical regions of text. A text region will include at least one text line and another text line or connected component that are vertically aligned. These may form a larger text area, discussed below, or may simply form a single vertical region. Generally, a group of text lines will use the same size font. This feature is used to identify text lines into horizontal features.

To detect a vertical region, the segmentator begins with a text line as identified above. The segmentator then searches for other text lines or connected components that are nearby and approximately the same height.

More specifically, the left boundary of the bounding box associated with the first text line must lie within 6 pixels of the candidate text line or connected component. If this condition is satisfied, then the vertical distance between the first text line and the candidate text line or connected component must be less than 15 pixels. If this condition is met, then the difference in height between the first text line and the candidate text line or connected component must be less than or equal to ten pixels. If this further condition is met, then the candidate text line or connected component is added with the first text line as a vertical region.

This process is repeated with any other candidate text lines or connected components. For subsequent candidate text lines, the bounding box of the candidate vertical region is used in the comparison of the left boundary and of the distance. The comparison of height is made with the height of the first text line only.

When the segmentator exhausts all candidate text lines or connected components, a further credibility test is applied. This checks that the number of elements exceeds 1. If so, the objects are grouped as a vertical region.

After identifying one vertical region, the segmentator repeats the process with any other candidate text lines and connected components. After the segmentator has exhausted the possibilities, it ends this step.

Next, at block 530, the segmentator searches for text areas. A text area is any vertical region by itself, or any vertical region having a bounding box that overlaps with the bounding box of another vertical region or text line. The segmentator searches through the vertical regions to establish text areas. After all possibilities are exhausted, this process is ended.

Next, at block 532, the segmentator proceeds to search for OCR lines. OCR lines are unique types of text lines that have uniform characters.

To initiate an OCR line, the segmentator searches the text lines and connected components. To qualify, a connected component must have a width of less than or equal to 16 and a height of less than or equal to 25 pixels. Likewise, for a text line to qualify, 70% of the connected components that form the text line must have a width that is greater than or equal to 10 and less than or equal to 16. In addition, 70% of the connected components that form the text line must have a height that is greater than or equal to 18 and less than or equal to 25.

After finding a candidate OCR line, the segmentator attempts to extend the area. To do so, the segmentator searches for other connected components that are nearby. To make this determination, the segmentator applies the following conditions. First, the vertical overlap of the candidate OCR line with the connected component and the vertical overlap of the connected component with the candidate OCR line are calculated. These calculations return two values. The larger must be greater than 0.8, and the smaller must be greater than 0.3. Second, the horizontal overlap of the candidate OCR line with the connected component and the horizontal overlap of the connected component with the candidate OCR line are calculated. Both of these must be less than or equal to zero.

In addition to searching for nearby connected components, the segmentator also applies the above rules to identify other candidate OCR lines. If any are found, they are compared to determine whether they should be joined as one OCR line. This determination is made by comparing their vertical overlap. Specifically, the vertical overlap of of each with respect to the other is calculated. Both measures must be greater than 0.6.

After joining any overlapping OCR lines, a credibility test is applied. To pass, the OCR line must have 6 or more elements.

Turning to FIG. 5B, one preferred data structure suitable for use with the segmentation process described with reference to FIG. 5A will be described. The structure of the database includes a connected component element 540. For a particular coupon, the database will include a number of connected components. These form the building blocks for all other object types.

As detailed above, connected components are grouped into a number of different objects. Specifically, one or more connected components 540 may be used to build a MICR object 542, a line 544, a horizontal region 546, or a barcode symbol 548.

A frame 550 is composed of one or more connected components 540 and one or more lines 544.

A logo 558 is composed of one or more lines 544, one or more connected components 540, and/or one or more horizontal region 546.

A text line 554 is composed of one or more horizontal region 546.

In some applications, a barcode may include an imbedded text line. In such applications, the above segmentation process adds another step to detect a barcode composite that includes both a barcode symbol 548 and a text line 554. The related data element is shown as barcode composite 556. As a check, the barcode symbol may be compared with the text to ensure that the two result in matching character sequences.

A table 552 includes at least one frame 550, one or more connected components 540 and may include one or more lines 544.

A vertical region 560 includes at least one text line 554 and may include connected components 540.

A text area 562 includes one or more vertical regions and may include one or more text lines 554.

Finally, an OCRA object 564 includes a text line 554 and may include one or more connected components 540.

Turning to FIG. 6A a sample coupon 600 is shown. The coupon has been scanned in black-and-white at a 200 dpi resolution. The sample coupon 600 includes information related to the vendor, Autoridad de Acueductors y Alcantarillados de Puerto Rico, as well as information related to the customer, Juan M., and his account.

FIG. 6B shows the sample coupon 600 along with the bounding boxes after applying connected component analysis. The connected components are identified by bounding boxes 602, 604, 606 and 608. Upon segmentation analysis, the connected component in bounding box 602 will be identified as a logo; the connected component in bounding box 604 will be identified as part of a text line; the connected component in bounding box 606 will be identified as part of a barcode; and the connected component in bounding box 608 will be identified as part of an OCR line.

Turning to FIG. 6C, the sample coupon 600 is shown along with the bounding boxes and associated data types. This data is obtained by the segmentation process described above. It includes a logo area 610, text lines 612, 614, 616, 618 and 620, OCRA 622, barcode 624, text area 626 and connected component 630.

The data resulting from the connected component analysis is saved as a table as shown in FIG. 7A. The segmentation process uses this table data when creating composite objects as described above. The connected component table includes type column 750. Initially all connected components are classified as such. Later, after segmentation analysis, they may be classified as other objects.

The table also includes an upper column 752, a left column 754, a lower column 756, a right column 758. These identify the pixel location of the bounding box associated with the connected component in the same row. The table also includes a height column 760 and a width column 762. These are calculated from the pixel locations of the bounding box.

The table further includes an area column 764, a density column 766 and an aspect ration column 768. The values of these columns are calculated as described above.

The data resulting from the segmentation analysis is also saved as a segmentation table as shown in FIG. 7B. It includes an object column 710, a type column 712, a left boundary column 714, a lower boundary column 718, a right boundary column 720, a height column 722, a width column 724, an area column 726, a density column 728 and an aspect ratio column 730. The values of these columns are calculated as described above with reference to the segmentation process. After application of the segmentator 312, this table classifies each area of a coupon image that contains information along with its type. The information from this table is then used in determining which vendor issued the coupon.

The coordinates from the segmentation table are used to determine the portion of the coupon image that will be provided to the optical character recognition engine. For example, with reference to FIG. 6C, only the portion of the image data defined by OCRA object 622 is provided to the optical character recognition engine. This provides a character string, length of OCR line, and position of spaces or special characters (and may include unique codes or mask and check digits). This data is compared to the database of coupon data to determine whether the coupon image matches a particular vendor type.

As discussed above, the coupon database includes specific conditions for generating a match. One preferred matching sequence is described with reference to FIG. 8.

Here, a sufficient set of conditions is that the coupon image includes an OCR line within a particular area and that the OCR line includes a particular character sequence as the initial characters of the OCR line. The OCR line is determined at block 810.

Another coupon may require as a sufficient set of conditions that the coupon image include an OCR line with a particular character string anywhere in the OCR line and include a barcode indicating a particular character string. In this instance, after generating a match for the OCR line conditions, the match coupon block 314 would proceed to check for the barcode information.

The barcode determination will be applied if a barcode object was identified in the segmentation process. The coordinates in the segmentation table are used to determine the portion of the coupon image that will be provided to the barcode engine. For example, with reference to FIG. 6, only the portion of the image data defined by barcode object 624 is provided to the barcode engine.

The barcode symbols are then translated into a text representation or character string using a barcode engine. The associated software is also commercially available from various vendors. The barcode engine performs a preprocessing phase, a skew correction phase, and a decoding phase.

Preferably the barcode preprocessor includes further morphological operations to separate any joined bars and to reconstruct incomplete bars. Techniques such as horizontal/vertical projection profiling, Hough transform, and nearest-neighbor clustering can be used to detect any skew present in the barcode. Finally, the decoding phase translates the barcode symbols into a text representation in accordance with the applicable barcode rules. Where the barcode symbol includes text area, the text area is then sent to the optical character recognition engine. A validation between the character sequence generated by the barcode and the associated text string is performed. If the validation fails, other objects are used to determine the coupon type.

Then, at branch 812, the unique ID conditions are checked. If the coupon meets the conditions, it has been positively identified and the matching algorithm terminates. For example, the character string resulting from the barcode engine is compared to the database of coupon data to determine whether it generates a match. Information such as the type of barcode, the length of the barcode, and unique codes or masks present in the barcode is used in the matching process. If such information satisfies a matching condition either alone or in combination with the information from the optical character recognition engine, then a coupon match is generated. Otherwise, a layout matcher is next applied to the coupon image.

At block 814, the layout matching is used to compare the position of predefined key objects in the input document to those documents in the knowledge base. In the layout matching process, the reference object is first searched to see whether the predefined objects have been identified for each document in the enrollment module and compare those with the objects present in the input document. The overlapping and the similarity that exist among objects in the input document and the reference objects are measurements that are then used to identify the coupon. After the reference objects have been successfully identified in the input document, the translation that exits among those objects and those predefined in the knowledge base is computed. After identifying the reference objects in the input image, other objects need to be matched as well to accurately identify an input document as a specific type.

Generally, the layout matcher does not, by itself, generate a match. It may identify one or more coupons that are likely to match. Previous OCR line or barcode sequences, or subsequent text matching or logo matching must be applied to confirm the match due to the relatively high level of uncertainty in this matching algorithm.

At branch 816, the unique ID conditions are checked. If the coupon meets the conditions, it has been positively identified and the matching algorithm terminates. Otherwise, it proceeds to block 818.

Here, a text matcher is applied. The text matcher uses portions of text in the coupon image that is useful in the identification of the coupon type. For example, the company name, its zip code, and its address are typical of useful regions in the identification process. The database of coupon data includes coordinate information for regions that provide information that may be used to identify the coupon. If the coordinate and type information from the segmentation table match an entry from the database of coupon data, then the optical character recognition engine is applied to the relevant portion of the coupon image. The resulting character string is compared to database entry. This check is typically performed in conjunction with the layout matcher algorithm.

At decision branch 820, the unique ID conditions are again checked. If the coupon meets the conditions, it has been positively identified and the matching algorithm terminates. Otherwise, it proceeds to the final matching algorithm at block 822.

The final matching algorithm is a logo matcher. It operates by comparing logo objects that have been identified by the segmentator block 312, with logo entries in the database of coupon data 315. The comparison is made by performing a correlation between the two entries. A high correlation indicates a match and a low correlation indicates a non-match. This matching algorithm preferably is not used alone, but rather in conjunction with other matching algorithms such as the text matcher.

Finally, at block 824, the unique ID conditions are checked. If the coupon meets the conditions, it has been positively identified and the matching algorithm terminates. Otherwise, the coupon is not recognized and an error message is returned. The matching algorithm then terminates at block 826.

Once the coupon type has been determined by the above matching process, the fields of interest are extracted at the extract information block 316. This operation is also referred to as zoning. The identified zones are passed to the optical character recognition engine, which converts them to text. Since the segmentator has already identified text lines and text areas, a comparison between the segmentation table and the zones of interest provides the necessary coordinate data for the relevant area on the coupon image. This area is passed to the optical character recognition engine.

After applying any of the above matching algorithms and comparing the resulting data to the coupon database, result may not produce enough data to satisfy a set of necessary conditions for a particular coupon type. Nonetheless, it may eliminate some of the coupon types from competition. To reduce processing requirements, the failing coupon types are eliminated from the competition when applying subsequent matching algorithms.

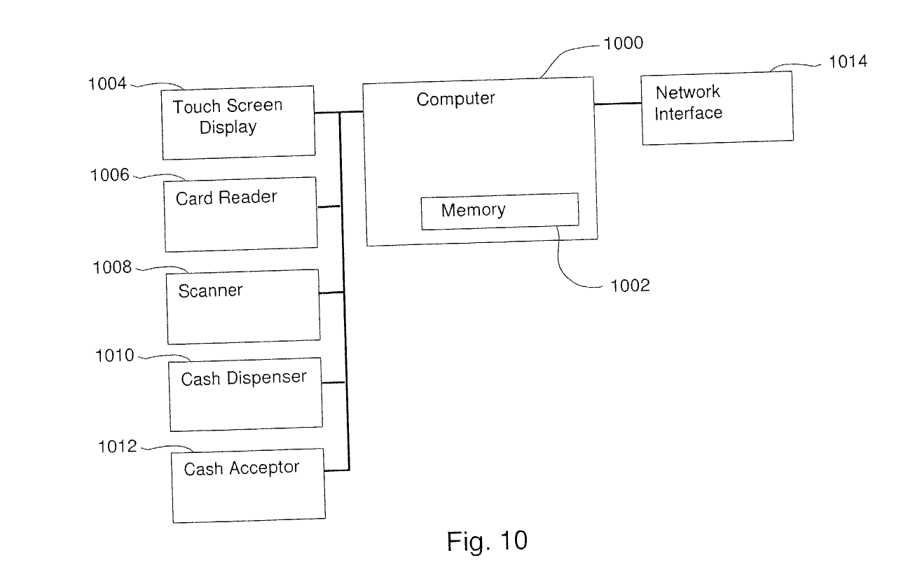

Turning to FIG. 10, one preferred system suitable for performing the above described functionality is described. More specifically, FIG. 10 shows a block diagram of one preferred automated transaction machine. The automated transaction machine includes a computer 1000 having a memory 1002. The computer 1000 connects with a touch screen display 1004. This interface is used to present visual information to a customer, and to receive instructions and data from the customer.

The computer 1000 also connects with a card reader 1006. The card reader 1006 is configured to receive a standard magnetic stripe card. Upon detecting a card, the card reader 1006 automatically draws the card across a magnetic sensor do detect card data. This information is provided to computer 1000.

The computer 1000 also connects with scanner 1008. The scanner 1008 is a standard black and white scanner. It is configured to receive a coupon from a customer. Upon receipt, the coupon is automatically drawn across an opto-electronic converter. The resulting image data is provided to computer 1000 for processing.

According to further aspects of the invention the computer 100 automatically determines the type of the coupon and the associated vendor. The computer 1000 then extracts customer account data from the coupon such as customer name, account number and outstanding balance. Details of this process have been described above.

The computer 1000 also connects with a cash dispenser 1010. The automated transaction machine may be used to perform the common functions of dispensing cash to a customer. The computer further connects with a cash acceptor 1012. This is used to accept paper currency from a customer, especially for the purpose of advancing payment toward a prepaid services account.

The computer 1000 also connects to network interface 1014. This is used to transmit transaction information with a remote information server.

Although the invention has been described with reference to specific preferred embodiments, those skilled in the art will appreciate that many variations and modifications may be made without departing from the scope of the invention. The following claims are intended to cover all such variations and modifications.

We claim:

1. A method of recognizing a coupon comprising the steps of:
scanning the coupon to generate an electronic representation;
comparing segments of the electronic representation with a defined category of patterns, wherein any segments that match one of the patterns is eliminated as noise;
identifying connected segments within the electronic representation;
applying a barcode search to at least one of the connected segments and any additional segments proximate thereto to determine whether the at least one of the connected segments forms a portion of a barcode sequence, and if so determining the alphanumeric characters associated with the barcode sequence;
applying an optical character recognition search to at least one of the connected segments and any additional segments proximate thereto to determine whether the at least one of the connected segments forms a portion of a text string, and if so determining the alphanumeric characters associated with the text string;
applying a table search to at least one of the connected segments to determine whether the at least one connected segments forms any portion of a table, and if so determining the boundaries and position of the table on the coupon; and
comparing the alphanumeric characters associated with the barcode sequence, the alphanumeric characters associated with the text string, and the boundaries and position of the table with a database of coupon data to determine whether the electronic representation matches a coupon type in the database of coupon data.

2. The method of claim 1, wherein the step of scanning the coupon comprises generating a black-and-white bit map divided into a grid of columns and rows so that each element of the grid is represented as either a black or a white bit and applying skew correction to the bit map.

3. The method of claim 2, wherein the step of detecting any connected segments comprises run-length encoding the electronic representation so that each row of the grid is represented by a plurality of start and end points that represent the start and end of a continuous run of elements and comparing the start and end points of adjacent rows to determine whether any start or end points fall between the start and end points of the adjacent rows.

4. The method of claim 1, wherein the step of comparing segments of the electronic representation with a defined category of patterns further comprises eliminating the central bit of the segments when the comparison generates a match, provided that the elimination of the central bit will not disconnect otherwise connected components.

5. The method of claim 1, wherein the steps of applying a barcode search and applying an optical character recognition search together comprise creating a table of coupon data that identifies a location and value of any barcodes and character strings that are detected.

6. The method of claim 5, wherein the step of comparing the alphanumeric characters associated with the barcode sequence, the alphanumeric characters associated with the text string, and the boundaries and position of the table with a database of coupon data further comprise comparing the location and value of any barcode sequence and any character strings that are detected with a listing of vendor data that includes a unique vendor identifier and an approximate location, and wherein the match is detected if the location and value of the barcode sequence or the character strings match an entry in the listing of vendor data.

7. The method of claim 6, further comprising the step of determining a customer account and an account balance after determining a coupon type associated with the matching vendor, wherein the customer account and the account balance are read from the table of coupon data.

8. A method of identifying a vendor, a customer and an account balance based upon the representation of a coupon comprising the steps of:
grouping image data into a plurality of interconnected segments;
applying barcode recognition to at least one of the interconnected segments to detect any barcode character sequences, wherein the barcode character sequences are associated with a barcode type;
applying optical character recognition to at least one of the interconnected segments to determine an optical character sequence, wherein the optical character sequence is associated with an optical character type;
applying text character recognition to at least one of the interconnected segments to determine a text character sequence, wherein the text character sequence is associated with a text type;
generating a table of the at least one barcode character sequence associated with the barcode type, the at least one optical character sequence associated with the optical character type, and the text character sequence associated with the text type; and
comparing at least one of:
the barcode character sequence associated with the barcode type;
the optical character sequence associated with the optical character type; and
the text character sequence associated with the text type;
to a database of vendor data and determining whether both the character sequence and the type associated therewith generate a match, wherein the match determines the vendor;
determining an expected location of a customer identifier and an expected location of an account balance based upon the determined vendor; and
determining the customer identifier and the account balance based upon the expected location and the table.

9. The method of claim 8, wherein the grouping image data into a plurality of interconnected segments further comprises run length coding.

10. The method of claim 9, further comprising the step of determining a plurality of bounding boxes, wherein each bounding box defines the limits of one of the plurality of interconnected segments.

11. The method of claim 10, further comprising the step of comparing the bounding boxes to a plurality of thresholds to identify interconnected segments comprising noise and to identify interconnected segments comprising an OCR character sequence.

12. The method of claim 11, wherein the bounding box associated with an interconnected segment identifies a height and a width, and wherein the plurality of thresholds includes a noise threshold, so that an interconnected segment is identified as noise if one of the height and width associated therewith does not exceed the noise threshold.

13. The method of claim 12, wherein the plurality of thresholds further comprises an OCR height range and an OCR width range, so that an interconnected segment is identified as an OCR character if the height falls within the OCR height range and the width falls within the OCR width range.

14. A computer system especially suitable for determining vendor, customer and account data associated with a coupon, comprising:
a scanner configured to generate an electronic representation of a coupon;
at least one data processor operationally coupled with the scanner and configured to:
compare segments of the electronic representation with a defined category of patterns so that any segments that match one of the patterns is eliminated as noise;
identify connected segments within the electronic representation;
apply a barcode search to at least one of the connected segments and any additional segments proximate thereto to determine whether the at least one of the connected segments forms a portion of a barcode sequence, and if so to determine the alphanumeric characters associated with the barcode sequence;
apply an optical character recognition search to at least one of the connected segments and any additional segments proximate thereto to determine whether the at least one of the connected segments forms a portion of a text string, and if so to determine the alphanumeric characters associated with the text string;
apply a table search to at least one of the connected segments to determine whether the at least one connected segments forms any portion of a table, and if so to determine the boundaries and position of the table on the coupon;
compare the alphanumeric characters associated with the barcode sequence, the alphanumeric characters associated with the text string, and the boundaries and position of the table with a database of coupon data to determine whether the electronic representation matches a coupon type in the database of coupon data.

15. The computer system of claim 14, wherein the scanner is further configured to generate a black-and-white bit map divided into a grid of columns and rows so that each element of the grid is represented as either a black or a white bit and wherein the scanner is further configured to apply skew correction to the bit map.

16. The computer system of claim 14, further comprising a memory operationally coupled with the at least one data processor and configured to store the defined set of patterns, and wherein the defined set of patterns are selected to avoid separating connected components.

17. The computer system of claim 16, wherein the memory is further configured to store the database of coupon data.
